(19) United States
(12) Patent Application Publication
(10) Pub. No.: US 2021/0304918 A1
(43) Pub. Date: Sep. 30, 2021

(54) INSULATED ELECTRICAL CABLE

(71) Applicant: Sumitomo Electric Industries, Ltd., Osaka-shi (JP)

(72) Inventors: Yutaka MATSUMURA, Osaka-shi (JP); Shigeyuki TANAKA, Osaka-shi (JP); Taro FUJITA, Osaka-shi (JP); Takaya KOHORI, Kanuma-shi (JP); Masayuki ISHIKAWA, Kanuma-shi (JP)

(73) Assignee: Sumitomo Electric Industries, Ltd., Osaka-shi (JP)

(21) Appl. No.: 17/268,179

(22) PCT Filed: Jul. 19, 2019
(86) PCT No.: PCT/JP2019/028491

§ 371 Date: Feb. 12, 2021

(30) Foreign Application Priority Data
Aug. 27, 2018 (JP) 2018-158425

(51) Int. Cl. H01B 7/02; H01B 7/04; H01B 7/18; B60R 16/02

(52) U.S. Cl. CPC H01B 7/025; H01B 7/0283; H01B 7/0009; H01B 7/1885; B60R 16/0215; H01B 7/04

(57) ABSTRACT

Provided is an insulted electrical cable including a core wire and a coating layer covering the core wire. The core wire is made up of at least one insulated wire including a conductor and an insulating layer covering the conductor. A coating member is disposed between the core wire and the coating layer to cover the core wire. A coefficient of kinetic friction between the coating member and the insulating layer at −30° C. is less than or equal to 0.20.

### TECHNICAL FIELD

The present disclosure relates to an insulated electrical cable. The present application claims priority to Japanese Patent Application No. 2018-158425 filed on Aug. 27, 2018, the disclosure of which is hereby incorporated by reference in its entirety.

### BACKGROUND ART

For an electric parking brake (EPB) system mounted on a vehicle, an insulated electrical cable (EPB cable) is used to electrically connect a caliper in a wheel house to an electronic control unit in the body of the vehicle. PTL 1 (Japanese Patent Laying-Open No. 2015-156386) discloses an insulated electrical cable including: an insulated wire made up of a conductor and an insulating layer covering the conductor; a core wire (stranded wire) formed of a plurality of the insulated wires twisted together; a first coating layer covering the core wire; and a second coating layer covering the first coating layer, and also discloses use of the insulated electrical cable as an EPB cable (paragraph 0020). The cable disclosed in PTL 1 is characterized by a tape member disposed between the core wire and the first coating layer and covering the core wire. The tape member may be removed to easily separate the core wire from the first coating layer and thereby expose the core wire.

### CITATION LIST

### Patent Literature

PTL 1: Japanese Patent Laying-Open No. 2015-156386

### SUMMARY OF INVENTION

The inventors of the present invention have conducted studies to eventually find that the flex resistance of the insulated electrical cable is improved by making the core wire in the cable easily movable without being restrained within the cable when the cable is flexed. The inventors have found that the flex resistance of the cable is improved by covering the outer periphery of the core wire with a coating member having a low frictional resistance against the insulating layer of the insulated wire which forms the core wire, to make the core wire easily movable within the cable when the cable is flexed, and accordingly reached the present disclosure including the following elements.

According to an aspect of the present disclosure, an insulated electrical cable includes:

a core wire made up of at least one insulated wire including a conductor and an insulating layer covering the conductor; and

a coating layer covering the core wire, and

the insulated electrical cable further includes a coating member, the coating member being disposed between the core wire and the coating layer and covering the core wire.

A coefficient of kinetic friction between the coating member and the insulating layer at −30° C. is less than or equal to 0.20.

### BRIEF DESCRIPTION OF DRAWINGS

FIG. 1 is a cross-sectional view showing a structure of an example embodiment of an insulated electrical cable of the present disclosure.

FIG. 2 is a cross-sectional view showing a structure of another example embodiment of an insulated electrical cable of the present disclosure.

FIG. 3 schematically shows a method of measuring the coefficient of kinetic friction in an Example.

FIG. 4 schematically shows a method of a bending test in an Example.

### DETAILED DESCRIPTION

### Problem to be Solved by the Present Disclosure

A cable mounted on a vehicle such as EPB cable is required to allow the core wire to be exposed easily and also to be resistant to stone damage while the vehicle is running (impact resistance, i.e., resistance to damage), for example. Further, the cable is required to be resistant to deterioration (such as break) resultant from repeated flexure of the cable while the vehicle is running (high flex resistance). For the EPB cable, use of the EPB cable in an environment from a low temperature of approximately −40° C. to a high temperature of approximately 120° C. has to be taken into consideration. Particularly at low temperatures, break due to repeated flexure, for example, is likely to occur. As such, improvement of the flex resistance, particularly at low temperatures, is required.

An object of the present disclosure is to provide an insulated electrical cable including: a core wire made up of at least one insulated wire including a conductor and an insulating layer covering the conductor; and a coating layer covering the core wire, and the insulated electrical cable can be used as an EPB cable, a cable for a wheel speed sensor (WSS), or the like, and is excellent in flex resistance relative to conventional cables, particularly superior in flex resistance at low temperatures.

### Advantageous Effect of the Present Disclosure

According to the present disclosure, an insulated electrical cable excellent in flex resistance, particularly an insulated electrical cable excellent in flex resistance at low temperatures can be provided.

### DESCRIPTION OF EMBODIMENTS OF THE PRESENT DISCLOSURE

In the following, embodiments of the present disclosure are described specifically. The present invention is not limited to the embodiments below, but includes all variations falling within the scope of claims as well as all variations equivalent in meaning and scope to the claims.

According to an aspect of the present disclosure, an insulated electrical cable includes:

a core wire made up of at least one insulated wire including a conductor and an insulating layer covering the conductor; and

a coating layer covering the core wire, and

the insulated electrical cable further includes a coating member, the coating member being disposed between the core wire and the coating layer and covering the core wire.

A coefficient of kinetic friction between the coating member and the insulating layer at −30° C. is less than or equal to 0.20.

In the insulated electrical cable of the present disclosure, the outer periphery of the core wire is covered with the coating member having a coefficient of kinetic friction at −30° C. of less than or equal to 0.20 against the insulating layer forming the insulated wire. The coating member of low friction against the core wire is disposed between the core wire and the coating layer to thereby make the core wire easily movable without being restrained within the cable when the cable flexes. As a result, the flex resistance even at low temperatures is improved, and deterioration (such as break) of the cable resultant from repeated flexure of the cable while the vehicle is running is suppressed.

First, each of elements that form the insulated electrical cable of the present disclosure is described.

### (1) Core Wire

The core wire is made up of at least one insulated wire. When the core wire is made up of a single insulated wire, the insulated wire itself is the core wire. When the core wire is made up of two or more (a plurality of) insulated wires, an assembly of these insulated wires is the core wire. When the core wire is an assembly of a plurality of insulated wires, the core wire may be a stranded wire made up of a plurality of insulated wires that are twisted together, for example. When the insulated electrical cable is an EPB cable, for example, the core wire may be formed by twisting together two or more insulated wires that have respective conductors with a cross-sectional area in a range from about 1.5 mm² to 3.0 mm² and have respective diameters substantially identical to each other. When the insulated electrical cable is a cable for signals or grounding, such as wheel speed sensor (WSS) cable, the core wire may be a single insulated wire having a conductor with a smaller cross-sectional area than the EPB cable, or the core wire may be formed by twisting together two or more insulated wires that have respective diameters substantially identical to each other (insulated wires having respective conductors with a smaller cross-sectional area than the EPB cable).

A single core wire may include insulated wires for two or more different uses. For example, a single core wire may also be formed by twisting together two or more insulated wires for EPB having respective conductors with a cross-sectional area in a range from about 1.5 mm² to 3.0 mm² and having respective diameters substantially identical to each other, and one or more insulated wires to be included in a cable for signals or for grounding, having respective conductors with a smaller cross-sectional area than the EPB wires and having respective diameters substantially identical to each other.

### (2) Insulated Wire

At least one insulated wire that forms the core wire includes a conductor and an insulating layer covering the conductor.

The conductor is a wire made of a material having electrical conductivity and flexibility, such as copper, aluminum, copper alloy, aluminum alloy, or the like. As the conductor, a stranded wire is often used that is made up of several tens to several hundreds of twisted thin elemental wires each having an outer diameter of approximately 0.1 mm. When the conductor is used for a power wire to be used for power feeding (EPB cable for example), the conductor has a cross-sectional area (the sum of respective cross-sectional areas of a plurality of elemental wires) in a range preferably from 1.5 mm² to 3.0 mm², more preferably from 1.6 mm² to 2.5 mm². When the conductor is used for a cable to be used as a signal wire (WSS cable for example) smaller in cross-sectional area than the power wire, a stranded wire is often used having the conductor with a cross-sectional area in a range preferably from 0.13 mm² to 0.5 mm², more preferably from 0.18 mm² to 0.35 mm².

The insulated wire can be formed by a method similar to that for usual insulated electrical wires. For example, the outer periphery of the conductor as described above can be covered with a resin by the melt extrusion to form the insulating layer. After the conductor is covered, the resin may be cross-linked by applying ionizing radiation or the like.

An example of the resin forming the insulating layer may be polyolefin resin, preferably flame-retardant polyolefin resin. For example, flame-retardant polyethylene to which the flame-retardant property is imparted by adding a flame retarder can form the insulating layer. Flame-retardant polyolefin resin can be used to form the insulating layer to ensure the flame-retardant property and the electrical insulation of the core wire (insulated wire) even when the core wire (insulated wire) is partially exposed by removal of the coating layer and the coating member such as tape member.

Examples of the polyolefin resin include, but are not limited to, high density polyethylene (HDPE), low density polyethylene (LDPE), linear low density polyethylene (LLDPE), very low density polyethylene (VLDPE), ethylene-vinyl acetate copolymer resin (EVA), ethylene-methyl acrylate copolymer resin (EMA), and ethylene-ethyl acrylate copolymer resin (EEA). Examples of the material that forms the insulating layer include other materials such as fluorine resin.

When the insulated wire is an EPB insulated wire to be used for an EPB cable, the thickness of the insulating layer is preferably in a range from 0.2 mm to 0.8 mm, more preferably in a range from 0.25 mm to 0.7 mm. The outer diameter of the insulating layer is preferably in a range from 2.5 mm to 4.0 mm, more preferably in a range from 2.5 mm to 3.8 mm.

### (3) Coating Member

The coating member is a coating member (film-like coating member, for example) having a coefficient of kinetic friction at −30° C. of less than or equal to 0.20, against the insulating layer forming the insulated wire. The coating member is disposed between the core wire and the coating layer and covers the entire outer periphery of the core wire. In the insulated electrical cable disclosed in PTL 1, the outer periphery of the core wire is also covered with a coating member (tape member). This the tape member is thin paper made of pulp, or synthetic fibers of a resin material such as polyester, for example, and accordingly has a coefficient of kinetic friction at −30° C. larger than 0.20, against the insulating layer. Therefore, the core wire is restrained from moving and thus hardly movable within the cable when flexed, which makes it impossible to achieve a high flex resistance.

In the present embodiment, the coating member made of a material having a coefficient of kinetic friction at −30° C. against the insulating layer of less than or equal to 0.20 is used to thereby achieve a high flex resistance of the cable. Because the cable has a high flex resistance at −30° C., it is apparent that the cable also has a high flex resistance at a temperature in a range from −40° C. to 0° C.

In terms of ease of covering, for example, preferably a tape member in the form of a tape is used as the coating member. Preferably, a method is used to wind the tape member around the outer periphery of the core wire so as to cover the entire outer periphery.

The tape member is required to have a strength that makes the tape member resistant to breakage resultant from repeated flexure. The tape member is usually wound around the outer periphery of the core wire, and therefore, the ease of winding is required in this case. Preferably, the thickness and the shape (width, for example) of the tape member and the material for the tape member are selected in consideration of the strength and the ease of winding.

In view of the above, examples of the material forming the tape member may include paper, nonwoven fabric, polyester paper, polyester film, nylon film, polyolefin film, polyimide film, liquid crystal polymer film, fluororesin film, and the like. Among them, paper or film made of polyester is preferred, and polyester paper or PET film, which is nonwoven fabric made of polyester such as polyethylene terephthalate (PET), is particularly preferred. In addition, for the purpose of reducing the friction coefficient and/or improving the film strength, for example, the surface may be treated by applying a releasing agent, a high-hardness resin or the like to the surface, metal plating or metal vapor-deposition may be applied to the surface, or metal foil may be bonded to the surface, for example.

The thickness of the coating member such as tape member is preferably in a range from 3 μm to 200 μm. If the thickness is less than 3 μm, the tape may be stretched while being wound around the outer periphery of the core wire, which may result in difficulty in handling. If the thickness is more than 200 μm, it is likely that the wound tape goes outward due to its high stiffness, so that the outer diameter of the coating layer that is applied after winding the tape may be unstable.

When the wire is covered with the coating member and thereafter the coating layer is formed around the outer periphery of the coating member by the melt extrusion for example of resin that is to form the coating layer, the coating member such as tape member is required not to melt or deform due to heating during the melt extrusion. It is therefore preferable that the coating member such as tape member is formed of a material having a higher melting point than the melting point of the material forming the coating layer. Specifically, the coating member is formed of a material having a melting point of 160° C. or more, for example, thermoplastic resin. If the melting point is less than 160° C., the coating member may melt or deform during the process of forming the coating layer around the coating member.

### (4) Coating Layer

The insulated electrical cable of the present disclosure includes the coating layer (sheath) that covers the outer periphery of the tape member (core wire) for protecting the core wire. The coating layer is required to be have resistance to stone damage for example (impact resistance) while the vehicle is running, flexibility for ensuring the flexibility of the cable, and high flex resistance that prevents conductor break and/or deterioration such as increase of the resistance of the conductor even if the cable is repeatedly flexed while the vehicle is running, for example.

The coating layer may be made up of two or more layers. In an insulated electrical cable to be mounted on a vehicle such as EPB cable or WSS cable, usually the coating layer has a double layer structure made up of a first coating layer (inner sheath layer) that covers the core wire covered with the tape member, and a second coating layer (outer sheath layer) that covers the first coating layer.

In order to improve the flexibility of the cable, preferably the material forming the first coating layer (inner sheath layer) has high flexibility. In particular, if the first coating layer (inner sheath layer) has a high elastic modulus at low temperatures, the cable has lower flex resistance at low temperatures. Therefore, preferably a material that is flexible at low temperatures is used in order to improve the flex resistance at low temperatures. The cable mounted on a vehicle is also required further to be excellent in wear resistance as well as thermal resistance, for example, and is often required to be flame-retardant.

(A) First Coating Layer (Inner Sheath Layer)

Examples of the material forming the first coating layer may include polyolefin resins such as polyethylene and ethylene vinyl acetate copolymer (EVA), polyurethane elastomer, polyester elastomer, and resins that are each a mixture of them. The first coating layer can be formed of a polyolefin resin to improve the flexibility at low temperatures of the cable and improve the flex resistance. The first coating layer can be formed of a polyurethane elastomer to improve the wear resistance of the cable. The first coating layer can be formed of a polyester elastomer to improve the thermal resistance of the cable. Among the resins exemplified above, polyethylene-based resins are particularly preferable in terms of cost saving, for example.

As a material forming the first coating layer, a resin containing VLDPE as a main component and having a small difference between the elastic modulus at a low temperature and the elastic modulus at a high temperature may also be used. Such a resin can be used to manufacture a cable having a high flex resistance in a wide temperature range from room temperature to low temperature. The resin containing VLDPE as a main component may be blended with any of other resins such as EVA, EEA, acid-modified VLDPE, and the like, to the extent that does not impair what is intended by the present disclosure.

To the extent that does not impair what is intended by the present disclosure, the material forming the first coating layer may contain any of various additives such as antioxidant, coloring agent, flame retarder, and the like.

For a power wire (EPB cable for example) to be used for power feeding, usually the thickness of the first coating layer is preferably in a range from 0.3 mm to 1.5 mm, more preferably in a range from 0.45 mm to 1.2 mm.

(B) Second Coating Layer (Outer Sheath Layer)

The second coating layer is an outer sheath layer of the cable. A cable such as EPB cable mounted on a vehicle is likely to be damaged due to stone damage or the like while the vehicle is running, and therefore, in order to suppress the damage, a resin excellent in resistance to scratch and/or wear resistance is required as the material forming the second coating layer. In order to make the cable flexible, the material is required to be excellent in flexibility. Further, when the cable is required to be flame-retardant, the second coating layer is required to be highly flame-retardant.

Thus, as the material forming the second coating layer, in terms of the resistance to scratch and the flexibility for example, preferably polyurethane resin is used, and preferably flame-retardant polyurethane resin is used, for example. For a power wire (EPB cable for example) to be used for power feeding, usually the thickness of the second coating layer is preferably in a range from 0.3 mm to 0.7 mm.

### (5) Example Embodiments of the Insulated Electrical Cable of the Present Disclosure

### (A) Example Embodiment 1

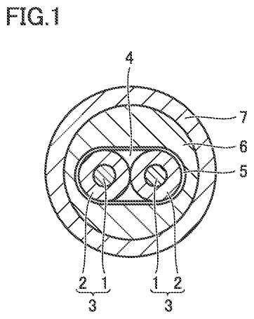

FIG. 1 is a cross-sectional view of an example embodiment of the insulated electrical cable of the present disclosure. The insulated electrical cable shown in FIG. 1 is a cable to be used as an EPB cable, includes a core wire made up of two insulated wires twisted together, and has a coating layer made up of two layers.

In FIG. 1, a conductor 1 is shown. Conductor 1 is a stranded wire formed by twisting together about 400 elemental wires made of a copper alloy and having an outer diameter of approximately 0.1 mm, and conductor 1 has an outer diameter of approximately 2 mm to 3 mm. The outer periphery of conductor 1 is covered with an insulating layer 2 made of a flame-retardant polyethylene and having a thickness of approximately 0.5 mm, and accordingly an insulated wire 3 is formed. Two insulated wires 3 thus formed are twisted together to form a core wire 4.

A tape member 5 is helically wound around the outer periphery of core wire 4 to cover the entire outer periphery of core wire 4. Tape member 5 is a tape of polyester paper having a coefficient of kinetic friction of 0.19 against insulating layer 2, and having a width of approximately 5 mm and a thickness of approximately 0.033 mm. Instead of the tape of polyester paper, a tape of another material having a coefficient of kinetic friction of less than or equal to 0.20 against insulating layer 2 may also be used as tape member 5. Examples of the other material may include a polyester resin film of PET, PBT and the like, a polyethylene film, and the like. The material, however, is not particularly limited as long as it has a coefficient of kinetic friction of less than or equal to 0.20 against insulating layer 2. Preferably, a material having a flexibility that enables easy winding, having a strength that imparts resistance to breakage due to flexure of the cable or the like, and not being caused to melt or deform for example due to the heat for forming the coating layer (melt extrusion of resin) is used.

In the insulated electrical cable of the embodiment shown in FIG. 1, the coating layer covering the outer periphery of tape member 5 (core wire 4) has a double layer structure made up of a first coating layer (inner sheath layer) and a second coating layer (outer sheath layer). In FIG. 1, a first coating layer 6 and a second coating layer 7 are shown.

First coating layer 6 is made of polyethylene and has a thickness of approximately 0.6 mm. Second coating layer 7 is made of polyurethane and has a thickness of approximately 0.5 mm. The material forming first coating layer 6 is not limited to polyethylene, and preferably a resin that improves the flame-retardant property, the wear resistance, and the flex resistance (flexibility) of the cable is used. The material forming second coating layer 7 is not limited to polyurethane, and preferably a resin that is excellent in the flame-retardant property, the resistance to scratch, and the flex resistance (flexibility) is used.

### (B) Example Embodiment 2

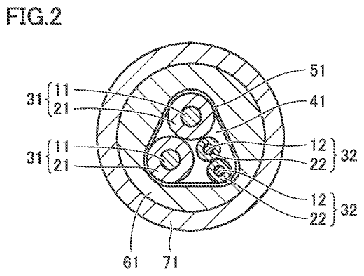

FIG. 2 is a cross-sectional view of another example embodiment of the insulated electrical cable of the present disclosure. The insulated electrical cable shown in FIG. 2 is a cable to be used for EPB and WSS, includes a core wire made up of four insulated wires twisted together, and includes a coating layer made up of two layers.

Referring to FIG. 2, a conductor 11 is a stranded wire formed by twisting together about 400 elemental wires made of a copper alloy and having an outer diameter of approximately 0.1 mm, and conductor 11 has an outer diameter of approximately 2 mm to 4 mm. The outer periphery of conductor 11 is covered with an insulating layer 21 made of a flame-retardant polyethylene and having a thickness of approximately 0.4 mm, and accordingly an insulated wire 31 is formed. Insulated wire 31 transmits electricity for the EPB. A conductor 12 is a stranded wire formed by twisting together 48 elemental wires made of a copper alloy and having an outer diameter of approximately 0.1 mm, and conductor 12 has an outer diameter of approximately 1.5 mm to 2.5 mm. The outer periphery of conductor 12 is covered with an insulating layer 22 made of a flame-retardant polyethylene and having a thickness of approximately 0.4 mm to 0.8 mm, and accordingly an insulated wire 32 is formed. Insulated wire 32 transmits electricity for the WSS. Two insulated wires 31 and two insulated wires 32 thus formed are twisted together to form a core wire 41.

A tape member 51 of polyester paper having a coefficient of kinetic friction of 0.19 against the flame-retardant polyethylene forming insulating layers 21 and 22 is helically wound around the outer periphery of core wire 41, to cover the entire periphery of core wire 41. As tape member 51, a tape having a width and a thickness similar to those of tape member 5 in Example Embodiment 1 may be used. As the material forming tape member 51, a material similar to that for tape member 5 may be used.

In the insulated electrical cable in the embodiment shown in FIG. 2, the coating layer covering the outer periphery of tape member 51 (core wire 41) has a double layer structure made up of a first coating layer (inner sheath layer) and a second coating layer (outer sheath layer). In FIG. 2, a first coating layer 61 and a second coating layer 71 are shown.

The thickness of first coating layer 61 may be similar to the thickness of first coating layer 6 in Example Embodiment 1, and the material forming first coating layer 61 may also be similar to the material for first coating layer 6. The thickness of second coating layer 71 may be similar to the thickness of second coating layer 7 in Example Embodiment 1, and the material for second coating layer 71 may also be similar to the material for second coating layer 7.

### (6) Method of Manufacturing the Insulated Electrical Cable of the Present Disclosure

Next, a method of manufacturing the insulated electrical cable of the present disclosure is described.

The insulated wire can be manufactured by covering the outer periphery of the conductor as described above, with an insulating resin that is a material to form the insulating layer. The conductor can be covered with the insulating resin by a method similar to that for manufacturing the known insulated wires, for example, by the melt extrusion of the insulating resin. After the insulating layer is formed, the resin forming the insulating layer may be cross-linked by applying ionizing radiation or the like, in order to improve the thermal resistance of the insulating layer.

The core wire may be made up of a single insulated wire. When the core wire is made up of two or more insulated wires, the two or more insulated wires manufactured in the above-described way are twisted together into the core wire. The insulated wires can be twisted together, for example, by feeding, to twisting means (device for twisting a plurality of insulated wires), the insulated wires respectively from two or more supply reels on which the insulated wires are wound.

The core wire thus formed is covered with a coating member. For example, a tape member fed from a tape supply reel (reel on which the tape member is wound) is wound around the core wire to thereby form a tape-covered core wire (core wire having its outer periphery covered with the tape member). The tape member is wound helically around the outer periphery of the core wire, for example.

The tape-covered core wire is conveyed to a first resin coating unit in which the outer periphery of the core wire is coated with a resin material such as polyethylene, and accordingly a first coting layer (inner sheath layer) is formed. The core wire can be coated with the resin material by, for example, the melt extrusion of the resin material onto the outer periphery of the tape-covered core wire. After the first coating layer is formed, the wire is conveyed to a second resin coating unit in which the outer periphery of the first coating layer is coated with a resin material for forming an outer sheath layer, and accordingly the second coating layer (outer sheath layer) is formed. Thus, the insulated electrical cable of the present disclosure having the coating layer made up of two layers, i.e., the inner sheath layer and the outer sheath layer, is manufactured. After the second coating layer is formed, electron beam or the like may be applied to the cable in order to cross-link the resin of the coating layer and thereby improve the scratch resistance, for example.

### EXAMPLES

In the following, the present disclosure is described specifically based on Examples. The present invention, however, is not limited to the following Examples.

(1) Materials Forming the Insulated Electrical Cable Subjected to Bending Test

The following materials were used to prepare an insulated electrical cable to be subjected to a bending test.

1) Material forming the insulating layer: flame-retardant polyethylene resin
2) Material forming the first coating layer (inner sheath layer): non-flame-retardant polyethylene resin
3) Material forming the second coating layer (outer sheath layer): non-flame-retardant polyurethane
4) Material forming the tape member

PET tape: 6 μm in thickness (Lumirror manufactured by Toray Industries, Inc.)

Polyester paper: 33 μm in thickness (manufactured by Tentok Paper Co., Ltd.)

Thin paper: 30 μm in thickness (manufacture by Daio Paper Corporation)

Teflon® tape: 50 μm in thickness (Naflon PTFE tape manufactured by Nichias Corporation)

Separator PET tape: 100 μm in thickness (manufactured by Mitsui Chemicals Tohcello, Inc.)

Aluminum foil/PET laminate film: 62 μm in thickness (Alu-PET manufactured by Panac Co., Ltd.)

PET tape: 25 μm in thickness (Diafoil manufactured by Mitsubishi Chemical Corporation)

Polyester paper: 25 μm in thickness (manufactured by Toyobo Co., Ltd.)

(2) Measurement of the Coefficient of Kinetic Friction of the Tape Member

For the tape member, its coefficient of kinetic friction at −30° C. against a material (flame-retardant polyethylene) forming the insulating layer was measured in the following way.

A sheet of 15 mm in width×30 mm in length was prepared from each of the above-indicated materials for the tape member and used as a movable friction material.

A sheet of 20 mm in width×120 mm in length×1 mm in thickness was prepared from the above-indicated material for the insulating layer and used as a stationary friction material.

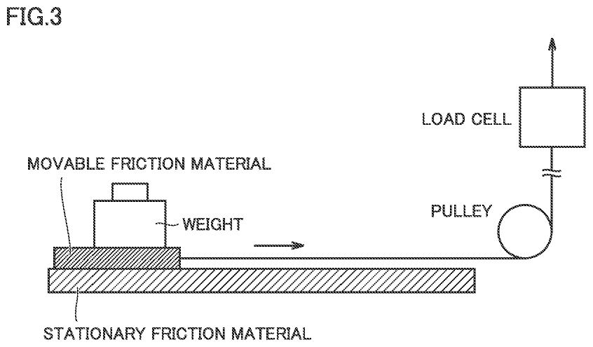

As schematically shown in FIG. 3, the movable friction material was placed on the stationary friction material, and a weight of 100 g was placed on the movable friction material to apply a load of 0.98 N to the movable friction material. In this state, the temperature of the movable friction material and the stationary friction material was adjusted to −30° C., and thereafter the movable friction material was pulled to be moved as shown in FIG. 3 at a test speed of 100 mm/min. The force (test force) required for pulling the material was measured, and the average of the test force for a distance of 10 mm to 20 mm over which the material was moved was defined as the frictional force. The frictional force thus obtained was divided by the load (0.98 N) to calculate the coefficient of kinetic friction. The measured coefficient of kinetic friction of each tape member is shown in Table 1.

(3) Preparation of the Insulated Electrical Cable Subjected to Bending Test

52 elemental wires each made of a copper alloy and having an outer diameter of 0.08 mm were twisted together into a stranded wire, and seven stranded wires were further twisted together into a stranded wire having an outer diameter of 2.0 mm, and this stranded wire was used as a conductor. Around the outer periphery of the conductor, an insulating layer having a thickness of 0.4 mm was formed by the melt extrusion of flame-retardant polyethylene, to thereby form an insulated wire.

Two insulated wires thus formed were twisted together to form a core wire. Around the outer periphery of the core wire thus prepared, a tape member shown in Table 1 was helically wound with a winding width of 3 mm to form a single layer covering the outer periphery of the core wire. The outer periphery of the core wire around which the tape member was wound was covered with non-flame-retardant polyethylene resin by the melt extrusion, to form a first coating layer of 0.5 mm in thickness. After this, it was covered with non-flame-retardant polyurethane by the melt extrusion, to form a second coating layer of 0.5 mm in thickness. Thus, a sample of the insulated electrical cable to be subjected to a bending test was prepared.

(4) Bending Test

On the prepared insulated electrical cable to be subjected to a bending test as described above, a bending test was conducted by a method according to JIS C 6851:2006 (optical fiber test procedures).

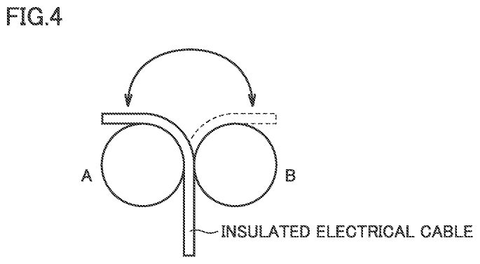

Specifically, as shown in FIG. 4, two mandrels A and B having a diameter of 60 mm were arranged in parallel in the horizontal direction, and the insulated electrical cable to be subjected to a bending test was held vertically between the mandrels. A process in which the upper end of the cable was bent by 90° in the horizontal direction to abut against an upper part of one mandrel A, and thereafter bent by 90° C. in the horizontal direction to abut against an upper part of the other mandrel B, was repeated in a constant-temperature bath at −30° C. During this repetition, two conductors in the cable were connected to measure the resistance value. The count of repetitions at the time when the resistance had increased to a resistance of 10 times as high as the original resistance value, was used as an indicator of the flex resistance (bending count 1 corresponds to a cycle in which the cable is bent rightward, then leftward, and then rightward again). The result is indicated in “bending count” in Table 1.

TABLE 1

| sample | | 1 | 2 | 3 | 4 | 5 | 6 | 7 | 8 |
|---|---|---|---|---|---|---|---|---|---|
| tape | material for | PET | Teflon | separator | AL/PET | polyester | thin | PET | polyester |
| member | tape member | tape | tape | PET tape | | paper | paper | tape | paper |
| | thickness (μm) | 6 | 50 | 100 | 62 | 33 | 30 | 25 | 25 |
| | coefficient of | 0.13 | 0.10 | 0.10 | 0.15 | 0.19 | 0.21 | 0.25 | 0.24 |
| | kinetic friction | | | | | | | | |
| | (−30° C.) | | | | | | | | |

| | | | | | | | | |
|---|---|---|---|---|---|---|---|---|
| bending count | 30000 | 50000 | 50000 | 25000 | 20000 | 7000 | 6000 | 6500 |

As shown in Table 1, the tape members having a coefficient of kinetic friction at −30° C. of 0.20 or less (Samples 1 to 5) have a higher bending count and therefore exhibit a higher flex resistance. In contrast, the tape members having a coefficient of kinetic friction at −30° C. of more than 0.20 (Samples 6 to 8) have a lower bending count and therefore exhibit a lower flex resistance. This result indicates that a tape member having a coefficient of kinetic friction at −30° C. of less than or equal to 0.20 can be used to achieve a high flex resistance of the insulated electrical cable.

### REFERENCE SIGNS LIST

1, 11, 12 conductor; 2, 21, 22 insulating layer; 3, 31, 32 insulated wire; 4, 41 core wire; 5, 51 tape member; 6, 61 first coating layer (inner sheath layer); 7, 71 second coating layer (outer sheath layer)

1. An insulated electrical cable comprising:
a core wire made up of at least one insulated wire including a conductor and an insulating layer covering the conductor; and
a coating layer covering the core wire,
the insulated electrical cable further comprising a coating member, the coating member being disposed between the core wire and the coating layer and covering the core wire,
a coefficient of kinetic friction between the coating member and the insulating layer at −30° C. being less than or equal to 0.20.

2. The insulated electrical cable according to claim 1, wherein the coating member has a thickness of more than or equal to 3 μm and less than or equal to 200 μm.

3. The insulated electrical cable according to claim 1, wherein the coating member is a tape member.

4. The insulated electrical cable according to claim 3, wherein the tape member is polyester paper or a polyethylene terephthalate film.

5. The insulated electrical cable according to claim 3, wherein the tape member is made of a thermoplastic resin having a melting point higher than a melting point of a material forming the coating layer.

6. The insulated electrical cable according to claim 1, wherein the coating layer includes a first coating layer covering the coating member and a second coating layer covering the first coating layer.

7. The insulated electrical cable according to claim 1, wherein the core wire includes at least two insulated wires that have respective diameters substantially identical to each other and respective cross-sectional areas of 1.5 to 3.0 mm².

8. The insulated electrical cable according to claim 1, wherein the insulated electrical cable is an insulated electrical cable to be mounted on a vehicle.

9. The insulated electrical cable according to claim 8, wherein the insulated electrical cable is an insulated electrical cable for an electric parking brake.
